(19) United States
(12) Patent Application Publication
(10) Pub. No.: US 2026/0273404 A1
(43) Pub. Date: Sep. 17, 2026

(54) ONE OR MORE NON-TRANSITORY COMPUTER-READABLE STORAGE MEDIA, INFORMATION PROCESSING SYSTEM, AND COMPUTER-IMPLEMENTED METHOD

(71) Applicant: NINTENDO CO., LTD., Kyoto (JP)

(72) Inventors: Koichi NAKAO, Kyoto (JP); Tsuyoshi NUMANO, Kyoto (JP); Mariko YAMADA, Kyoto (JP)

(21) Appl. No.: 19/556,619

(22) Filed: Mar. 4, 2026

(30) Foreign Application Priority Data
Mar. 13, 2025 (JP) 2025-040191

(51) Int. Cl. A63F 13/537

(52) U.S. Cl. CPC A63F 13/537; A63F 2300/638

(57) ABSTRACT

One or more non-transitory computer-readable storage media have stored therein instructions that, when executed, cause one or more processors to perform operations comprising: displaying an animated frame that surrounds a display area where a content image is displayed; and switching a display mode of the frame from a first display mode to a second display mode that stands out less than the first display mode in a case where the display area indicated by the frame is an area whose content image changes.

### CROSS REFERENCE TO RELATED APPLICATION

This nonprovisional application is based on Japanese Patent Application No. 2025-40191 filed with the Japan Patent Office on Mar. 13, 2025, the entire contents of which are hereby incorporated by reference.

### FIELD

The present disclosure relates to a user interface for indicating a content item.

### BACKGROUND AND SUMMARY

Conventionally, there has been a known technique in which a content image related to a content item is displayed and a user selects the content image (JP 2010-176321 A).

The present disclosure improves the visibility of a selected content item or an indicator for indicating a content item according to the situation.

### Configuration 1

One or more non-transitory computer-readable storage media have stored therein instructions that, when executed, cause one or more processors to perform operations comprising: displaying an animated frame that surrounds a display area where a content image is displayed; and switching a display mode of the frame from a first display mode to a second display mode that stands out less than the first display mode in a case where the display area indicated by the frame is an area where the content image displayed in the area changes.

This configuration causes the frame to be animated, and therefore makes it easy to perceive which content item is indicated. Moreover, since the frame is set to the second display mode that stands out less than the first display mode if the content image can change, it is easy for the user to, for example, pay attention to a change in the content image.

### Configuration 2

In the one or more non-transitory computer-readable storage media according to Configuration 1, the switching of the display mode of the frame may further comprise: switching the display mode of the frame to the second display mode at the same time as the content image displayed in the display area surrounded by the frame changes. This configuration causes the user to pay attention to a change in the content image, and therefore makes the change in the display mode of the frame less noticeable.

### Configuration 3

In the one or more non-transitory computer-readable storage media according to Configuration 1 or 2, the switching of the display mode of the frame may further comprise: switching the display mode of the frame to the second display mode after a specified time has elapsed since the content image displayed in the display area surrounded by the frame changed.

### Configuration 4

In the one or more non-transitory computer-readable storage media according to any of Configurations 1 to 3, the operations may further comprise: changing the content image displayed in the display area surrounded by the frame in accordance with a user operation.

### Configuration 5

In the one or more non-transitory computer-readable storage media according to any of Configurations 1 to 4, the switching of the display mode of the frame may further comprise: switching the display mode of the frame to the second display mode after a specified time has elapsed since the content image changed in a case where the content image displayed in the display area surrounded by the frame is a content image that can be changed in accordance with a user operation; and switching the display mode of the frame to the second display mode at the same time as the content image changes in a case where the content image displayed in the display area surrounded by the frame is a content image that cannot be changed in accordance with a user operation.

### Configuration 6

In the one or more non-transitory computer-readable storage media according to Configuration 4, the operations may further comprise: when the display mode of the frame is the second display mode, maintaining the second display mode regardless of whether the content image displayed in the display area is changed in accordance with a user operation or not. This configuration causes the second display mode to be maintained once the display mode is switched to the second display mode, and therefore can suppress frequent switching of the display mode of the frame.

### Configuration 7

In the one or more non-transitory computer-readable storage media according to Configuration 1, the switching of the display mode of the frame may further comprise: switching the display mode of the frame to the second display mode after a specified time has elapsed since the content image displayed in the display area surrounded by the frame changed; and when the content image displayed in the display area is changed in accordance with a user operation before the specified time has elapsed, switching the display mode of the frame to the second display mode after the specified time has elapsed since the change.

When the content image is changed in accordance with a user operation, the specified time is measured starting from the time of the change, which can suppress frequent switching of the display mode of the frame.

### Configuration 8

In the one or more non-transitory computer-readable storage media according to Configuration 7, the operations may further comprise: when the display mode of the frame is the second display mode, maintaining the second display mode regardless of whether the content image displayed in the display area is changed in accordance with a user operation or not. This configuration causes the second display mode to be maintained regardless of a user operation once the display mode is switched to the second display mode, and therefore can suppress frequent switching of the display mode of the frame.

### Configuration 9

In the one or more non-transitory computer-readable storage media according to any of Configurations 1 to 8, transparency of the frame in the second display mode may be higher than in the first display mode. This configuration causes the second display mode to stand out less than the first display mode regardless of the background color.

### Configuration 10

In the one or more non-transitory computer-readable storage media according to any of Configurations 1 to 9, the transparency of the frame may be set higher in a dark mode than in a light mode. Although the frame tends to stand out more in the dark mode than in the light mode, this configuration causes the frame to stand out less even in the dark mode.

### Configuration 11

In the one or more non-transitory computer-readable storage media according to any of Configurations 1 to 10, an animation speed of the frame in the second display mode may be lower than in the first display mode.. This configuration causes the frame to stand out less in the second display mode than in the first display mode.

### Configuration 12

In the one or more non-transitory computer-readable storage media according to any of Configurations 1 to 11, the change of the content image may be a playback of a moving image.

### Configuration 13

In the one or more non-transitory computer-readable storage media according to any of Configurations 1 to 11, the change of the content image may be switching from a still image to another still image.

### Configuration 14

In the one or more non-transitory computer-readable storage media according to Configurations 1 to 12, the content image may be an image of a game.

### Configuration 15

An information processing system one or more processors and one or more non-transitory computer-readable storage media having stored therein instructions that, when executed, cause the one or more processors to perform operations comprises: displaying an animated frame that surrounds a display area where a content image is displayed; and switching a display mode of the frame from a first display mode to a second display mode that stands out less than the first display mode in a case where the display area indicated by the frame is an area whose content image changes.

### Configuration 16

In the information processing system according to configuration 15, the switching of the display mode of the frame may comprise switching the display mode of the frame to the second display mode at the same time as the content image displayed in the display area surrounded by the frame changes.

### Configuration 17

In the information processing system according to configuration 15, the switching of the display mode of the frame may comprise: switching the display mode of the frame to the second display mode after a specified time has elapsed since the content image displayed in the display area surrounded by the frame changed; and when the content image displayed in the display area is changed in accordance with a user operation before the specified time has elapsed, switching the display mode of the frame to the second display mode after the specified time has elapsed since the change.

### Configuration 18

A computer-implemented method comprises the steps of: displaying an animated frame that surrounds a display area where a content image is displayed; and switching a display mode of the frame from a first display mode to a second display mode that stands out less than the first display mode in a case where the display area indicated by the frame is an area whose content image changes.

### Configuration 19

In the computer-implemented method according to configuration 18, the switching of the display mode of the frame may comprise switching the display mode of the frame to the second display mode at the same time as the content image displayed in the display area surrounded by the frame changes.

### Configuration 20

In the computer-implemented method according to configuration 18, the switching of the display mode of the frame may comprise: switching the display mode of the frame to the second display mode after a specified time has elapsed since the content image displayed in the display area surrounded by the frame changed; and when the content image displayed in the display area is changed in accordance with a user operation before the specified time has elapsed, switching the display mode of the frame to the second display mode after the specified time has elapsed since the change.

The foregoing and other objects, features, aspects and advantages of the exemplary embodiments will become more apparent from the following detailed description of the exemplary embodiments when taken in conjunction with the accompanying drawings.

### BRIEF DESCRIPTION OF THE DRAWINGS

FIG. 1 is a block diagram showing an example of a configuration of an information processing apparatus of an embodiment;

FIG. 2 is a schematic drawing showing a relation between a content provision server and a game apparatus;

FIG. 3A shows an example of a screen displaying a list of games;

FIG. 3B shows the example of the screen displaying the list of games;

FIG. 4A illustrates an animation of a frame;

FIG. 4B illustrates the animation of the frame;

FIG. 5 shows the example of the screen displaying the list of games;

FIG. 6 shows control of the game apparatus;

FIG. 7 shows an example of a game detail screen;

FIG. 8 shows control of the game apparatus; and

FIG. 9 shows control of the game apparatus.

### DETAILED DESCRIPTION OF NON-LIMITING EXAMPLE EMBODIMENTS

Now, an information processing system and an information processing program of an embodiment will be described with reference to the drawings. It should be noted that the following description is merely illustrative of preferred modes and is not intended to limit the disclosure described in the claims.

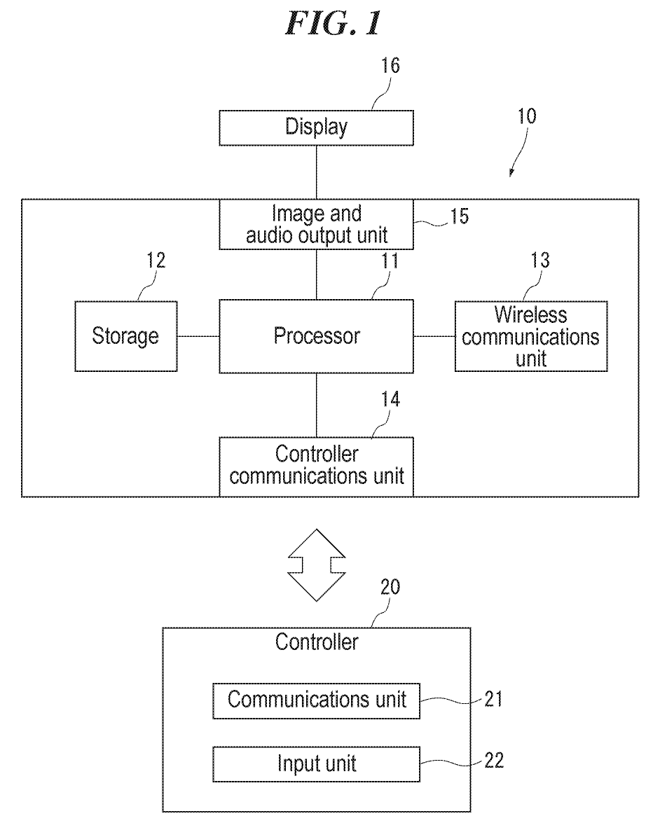

FIG. 1 is a block diagram showing an example of a configuration of an information processing system 10 of the embodiment. The information processing system 10 is, for example, a smartphone, a stationary or portable game apparatus, a tablet terminal, a mobile phone, a personal computer, a wearable terminal, a server, or the like. The information processing system may comprise a plurality of apparatuses. Components of each apparatus, each apparatus, and the apparatuses are examples of the "one or more processors." The embodiment will be described with a game apparatus cited as the information processing system 10. The information processing system 10 is hereinafter referred to as the "game apparatus 10".

In FIG. 1, the game apparatus 10 has a processor 11. The processor 11 is an information processing unit that executes various information processes executed in the game apparatus 10, and may comprise, for example, only a CPU (Central Processing Unit), or an SoC (System-on-a-Chip) that includes a plurality of functions such as a CPU function and a GPU (Graphics Processing Unit) function. The processor 11 executes an information processing program (e.g., a game program and a UI control program) stored in a storage 12 to execute the various information processes. It should be noted that the storage 12 may be, for example, an internal storage medium such as flash memory and DRAM (Dynamic Random Access Memory), or configured to use an external storage medium or the like mounted in a not shown slot.

The game apparatus 10 may perform wired or wireless communications with another game apparatus and a specified server apparatus. The game apparatus 10 has a wireless communications unit 13 to communicate wirelessly. Internet communications and short-range wireless communications, for example, are used as the wireless communications. The game apparatus 10 also has a controller communications unit 14 for performing wired or wireless communications with a controller 20.

The game apparatus 10 has an image and audio output unit 15 for outputting images and audio generated by the processor 11 to an integrated or external display 16. The image and audio output unit 15 is, for example, a connector to which the external display 16 is connected. The image and audio output unit 15 may be, for example, the wireless communications unit 13 or the processor 11.

The controller 20 comprises a communications unit 21 and an input unit 22. The input unit 22 comprises various buttons, analog sticks, and the like. The communications unit 21 has a function to perform wired or wireless communications with the controller communications unit 14 described above. Information on an operation input entered into the input unit 22 and various detection results obtained by an inertial sensor are output to the communications unit 21 repeatedly in a timely manner, and are sent to the controller communications unit 14.

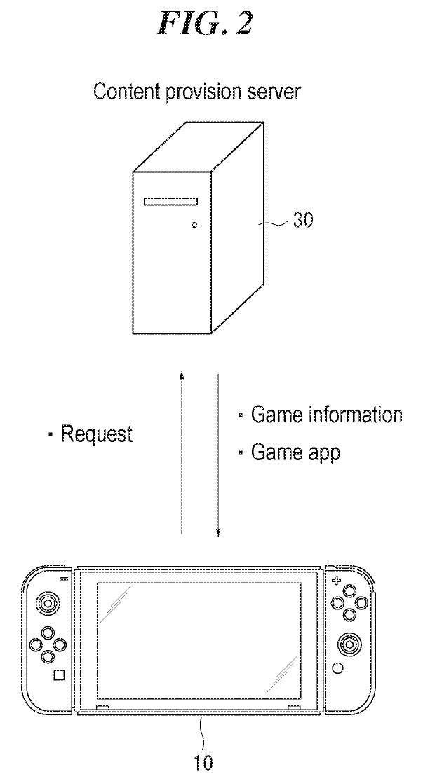

FIG. 2 is a schematic drawing showing a relation between a content provision server 30 and the game apparatus 10. The game apparatus 10, for example, communicates with the content provision server 30 via the wireless communications unit 13, and receives game applications and game information. The content provision server 30, for example, provides the game apparatus 10 with a distribution function for game applications and sends game information, which is information on available game apps, to the game apparatus 10 in response to a request from the game apparatus 10. Game information includes, for example, a moving image, a picture, a screenshot, a captured image, or other pieces of information. The game apparatus 10 displays a moving image, a picture, a screenshot, a captured image, or the like on a screen.

Although the embodiment describes the example in which the content provision server 30 distributes game applications, content items provided by the content provision server 30 are not limited to game applications. For example, the content provision server 30 may provide a movie, an electronic book, music, or the like as a content item. Alternatively, it is not required for the content provision server 30 to provide content items and content information, and different servers may perform their respective processes. There is no limitation on a server that performs payment processing or other processes, too.

The game apparatus 10 has a function to display a screen for introducing games based on game information received from the content provision server 30 and accept a user's selection operation for a game to be purchased. The game apparatus 10 executes a UI control program stored in the storage 12 to realize screen control of a game introduction screen. The screen control of a game introduction screen will be described below.

### First embodiment

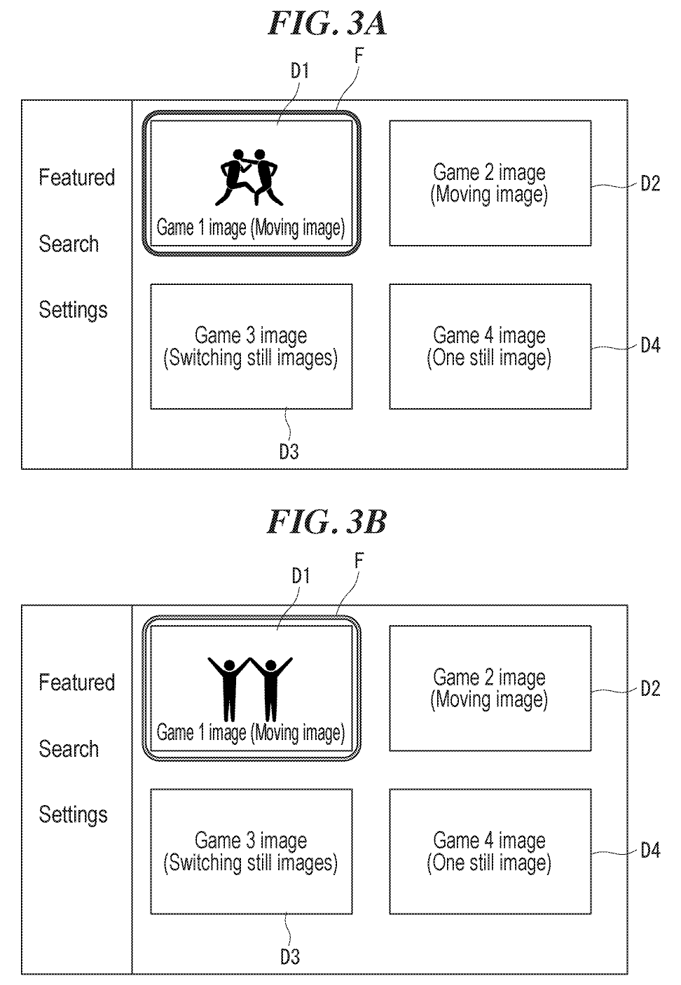

FIGS. 3A and 3B illustrate the screen for introducing games. FIG. 3B shows a state where a time has elapsed since the time point of FIG. 3A.

The game apparatus 10 has, for example, an application for introducing games to users. When a user runs the application, the screen shown in FIG. 3 is displayed. There are menu items "Featured," "Search," and "Settings" in a left-side area of the screen, operations of each function of which can be executed by selecting and confirming one of these items.

FIGS. 3A and 3B illustrate an example of the screen in a state where "Featured" is confirmed and a list of games is displayed. This screen is hereinafter referred to as the "game list screen." The game list screen comprises a plurality of display areas D1 to D4 for displaying games. The display areas D1 to D4 are referred to as "Display area D" when they are not individually specified. A still image or a moving image of each game may be displayed in each of the display areas D1 to D4. For example, a moving image of Game 1 may be displayed in the display area D1, a moving image of Game 2 may be displayed in the display area D2, switching still images of Game 3 may be displayed in the display area D3, and a still image of Game 4 may be displayed in the display area D4. It should be noted that games 1 to 4 are different from one another. Playback of a moving image or switching of still images is started when a frame F described later is located in corresponding Display area D. For example, when the frame F is located to surround the display area D1, a moving image of Game 1 is played back. At this time, a moving image of Game 2 is not played back, and switching of still images of Game 3 is not started. Which type of image is displayed in Display area D varies depending on the content of introduction information of each game.

Although the game list screen has the four display areas D1 to D4 for displaying games in a list in the example shown in FIG. 3, the number of Display areas D may be greater than or less than four. The screen may be caused to be scrollable when Display areas D are too many to fit in one screen.

On the game list screen, one of Display areas D can be indicated by the frame surrounding the area. The frame is an example of a cursor for indicating Display area D. The frame may be able to indicate a menu item. In FIG. 3A, the display area D1 displaying Game 1 is indicated by the frame surrounding the area. The frame in the embodiment has a function to be animated. The frame is displayed with an animation effect, and clearly indicates that the corresponding display area D1 is selected.

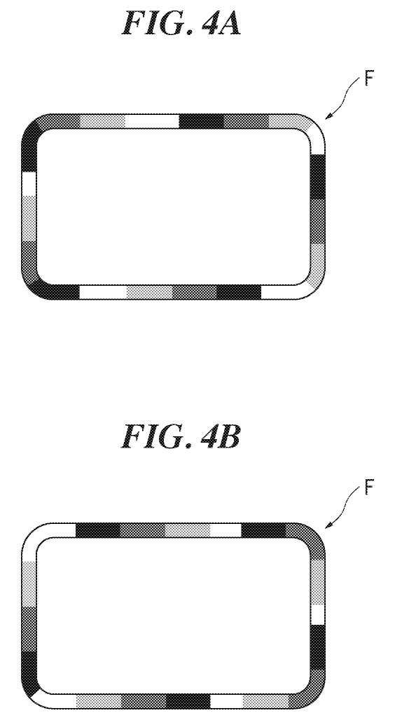

FIGS. 4A and 4B illustrate an animation of the frame of the embodiment. As shown in FIG. 4A, the frame F is applied with a colored pattern comprising a plurality of colors. This colored pattern circulates along the frame with animation processing. The colored pattern of the frame F shown in FIG. 4A moves over time and changes to the colored pattern of the frame F shown in FIG. 4B. The circulation-like change in the colored pattern of the frame improves the visibility of the frame, and facilitates identifying the selected content. It should be noted that that FIG. 4 shows just an example of the animation, and other animations may be adopted. For example, the animation may be an animation in which arrows or other icons move within the frame, or an animation in which the shape of the frame changes.

Next, the change in the display mode of the frame will be described. The frame F indicating Display area D of the Game 1 image as shown in FIG. 3A changes from a first display mode to a second display mode shown in FIG. 3B at the same time as the Game 1 image changes. If the Game image is a moving image as the Game 1 image, the display mode of the frame changes at a time when the moving image is started. If a plurality of still images are switched and displayed as the Game 3 image, the display mode of the frame changes at a time of the first switching. The Game 4 image is one still image, and when a content image in Display area D does not change like this, the display mode of the frame is not changed and maintained to be the first display mode.

The second display mode is a display mode in which the frame stands out less than in the first display mode. In the embodiment, the frame has a higher transparency in the second display mode than in the first display mode. This makes the frame closer to the background color and thereby less noticeable. Additionally, the transparency of the frame in the second display mode may be set higher when the screen is in a dark mode than in a light mode. Since the frame is likely to stand out more in the dark mode than in the light mode, the highly set transparency can suppress the noticeability.

The frame is depicted in a uniform color in FIG. 3 for convenience of description, but is actually animated as shown in FIG. 4. The speed of the animation is lower in the second display mode than in the first display mode in the embodiment. Reducing the animation speed provides an advantage of suppressing the visibility of the frame. The speed reduction also includes stopping. Although some examples of the second display mode are cited in the embodiment, there may be other methods for making the frame less noticeable. For example, other methods such as decreasing the contrast to the background, lowering the brightness and saturation of the frame, and reducing the thickness of the frame may be adopted.

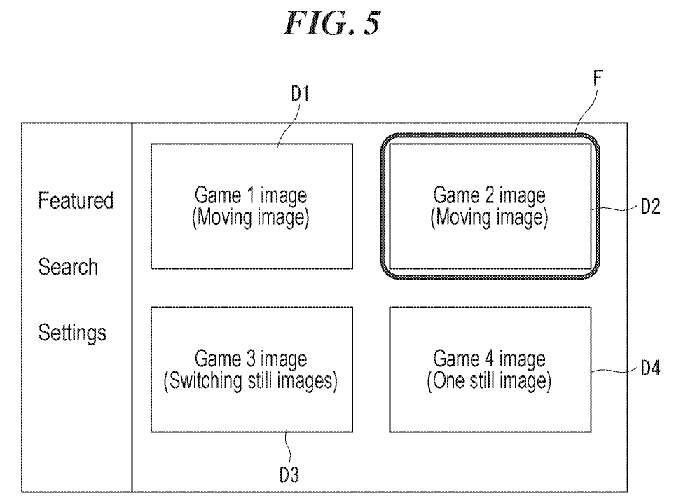

The display mode of the frame returns from the second display mode to the first display mode when Display area D indicated by the frame changes to another Display area D. FIG. 5 shows a screen example in which an operation input for moving to the right is entered in the state of FIG. 3B. The frame F, which indicated the Game 1 image in FIG. 3B, indicates Game 2 as shown in FIG. 5. The display mode of the frame F then returns from the second display mode to the first display mode. Meanwhile, the image of Game 1 may be restored to its initial image shown in FIG. 3A, may be the one being played back, for example, immediately before the movement of the the frame F as shown in FIG. 3B, or may be another image.

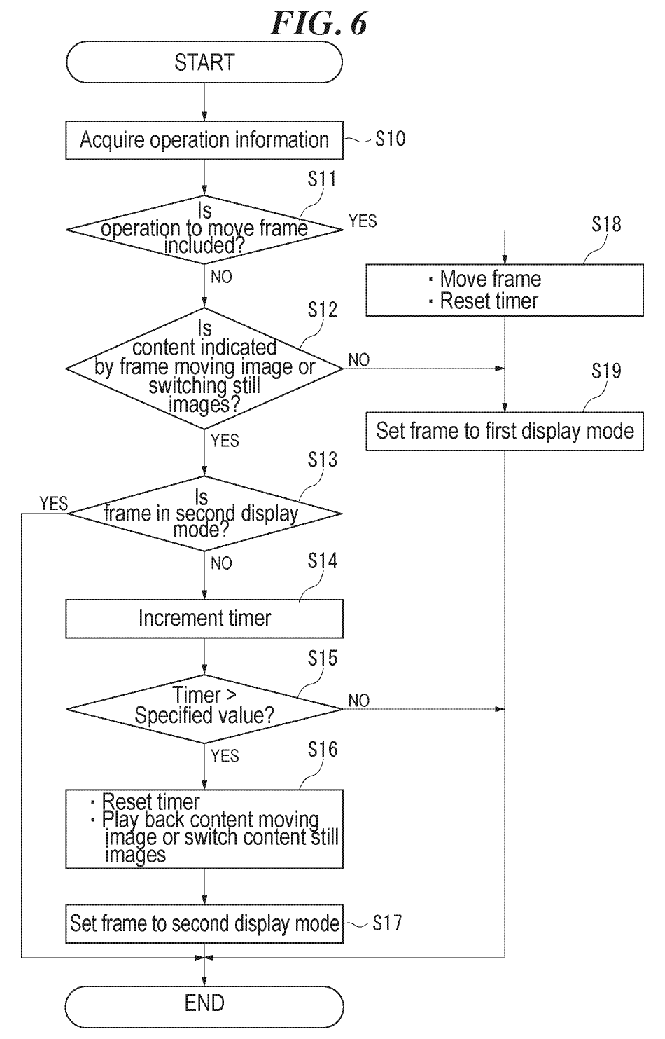

FIG. 6 shows control of the game apparatus 10 realized by executing the UI control program. The process shown in FIG. 6 is performed in a state where the game list screen shown in FIG. 3 is displayed. The process shown in FIG. 6 is performed, for example, every frame. Available operations on the game list screen shown in FIG. 3 are moving the frame and selecting a menu item or a game indicated by the frame. If a selected menu item is confirmed, a function corresponding to the confirmed menu item is performed, and if a selected game is confirmed, the screen moves to the game's detail screen. FIG. 6 exclusively describes the operation to move the frame.

When acquiring operation information from the input unit 22 (S10), the game apparatus 10 determines whether the information includes the operation to move the frame or not (S11). If the operation to move the frame is not included (NO at S11), the game apparatus 10 determines whether the content item indicated by the frame is either a moving image or switching still images, or neither (S12). As shown in FIG. 3A, content items fall into categories: moving images; switching images; and still images.

If the determination at the step S12 indicates that the content item indicated by the frame is a moving image or switching still images, the game apparatus 10 determines whether the frame is in the second display mode or not (S13). If the frame is not in the second display mode, the game apparatus 10 increments a timer (S14). This timer is for measuring the time until the start of playing a moving image or the time until the first switching of switching still images of the content item indicated by the frame.

The game apparatus 10 then determines whether the timer exceeds a specified value or not (S15). If the timer does not exceed the specified value (NO at S15), the game apparatus 10 ends the process without doing anything. If the timer exceeds the specified value, the game apparatus 10 resets the timer, and plays back the moving image or switches the still images (S16). The game apparatus 10 then sets the display mode of the frame to the second display mode (S17). That is, the game apparatus 10 sets the display mode of the frame to the second display mode at the same time as the playback of the moving image or the switching of the still images.

If the determination of whether the operation to move the frame is included or not (S11) indicates that the operation to move the frame is included (YES at S11), the game apparatus 10 moves the frame and resets the timer (S18). The game apparatus 10 then sets the frame to the first display mode (S19).

### Second embodiment

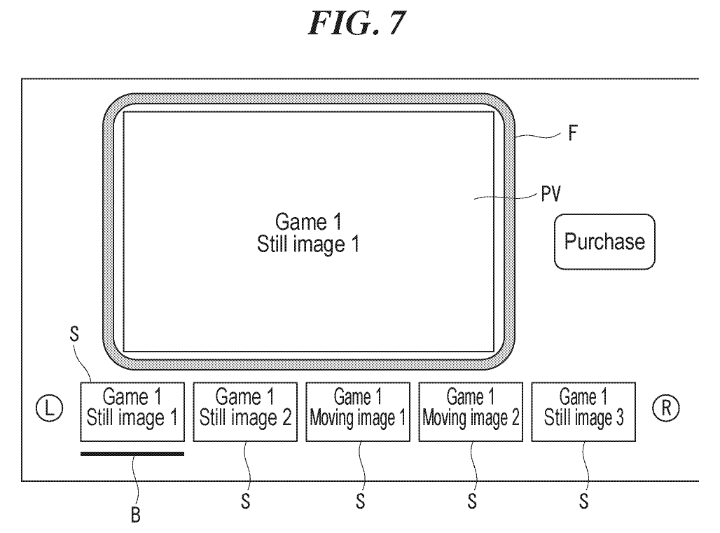

An operation on a detail screen indicating information on a game will be described as another example of the screen control. FIG. 7 shows an example of a game detail screen. As one example, when a game is confirmed while it is selected on the game list screen, the screen transitions to the game's game detail screen. It should be noted that the method for the transition to a game detail screen is not limited to this. A preview area PV is placed approximately in the center of the screen. The preview area PV is for displaying a still image or moving image of the selected game. A purchase button is provided to the right of the preview area PV. If the user selects and confirms this purchase button, the operation moves to a purchase procedure for the game, and a purchase operation is performed. Objects to be indicated by the frame on a game detail screen in the embodiment are the preview area PV and the purchase button.

Images S, one of which corresponds to a moving image or still image being displayed in the preview area PV, are arranged side-by-side on the bottom of the preview area PV. A bar B indicating an image S corresponding to the moving image or still image being displayed in the preview area PV is displayed below the image S. "L" and "R" on both sides of the images S indicate that an operation using L and R buttons allows for changing the image to be displayed in the preview area PV. In other words, the L and R buttons comprise an interface for causing the user to select a content item to be displayed in the preview area PV. Additionally, in the embodiment, when, for example, a specified time has elapsed without any user operation since the screen transitioned to a game detail screen, auto advance starts even if the user does not select an image S, and a still image or moving image displayed in the preview area PV switches to another. Once the auto advance is started, content items displayed in the preview area PV switch successively, and the bar B below one of the images S moves accordingly.

In a game detail screen, the frame indicating the preview area PV is displayed in the first display mode when the screen moves to the game detail screen and the frame indicates the preview area PV or when the frame temporarily moves to the purchase button and returns to the preview area PV. The display mode of the frame of the preview area PV is then changed from the first display mode to the second display mode after a specified time has elapsed since a moving image in the preview area PV started or since a still image therein was displayed.

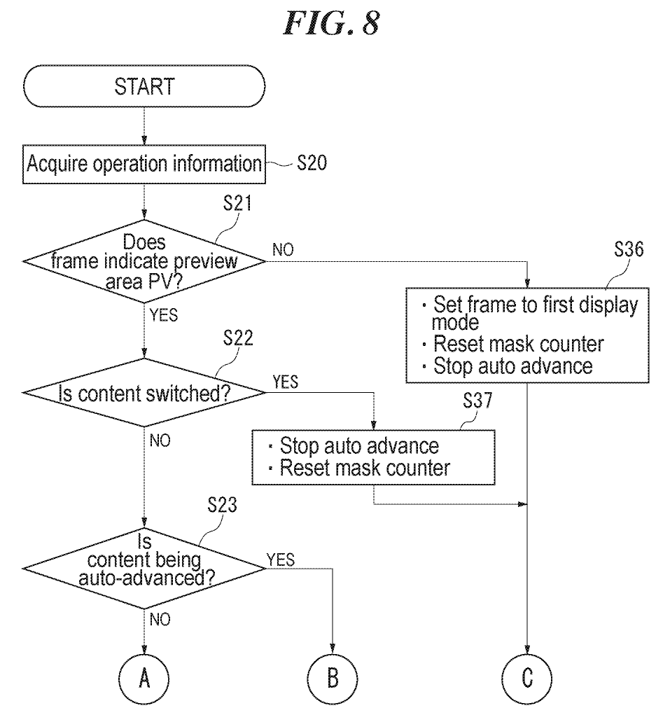

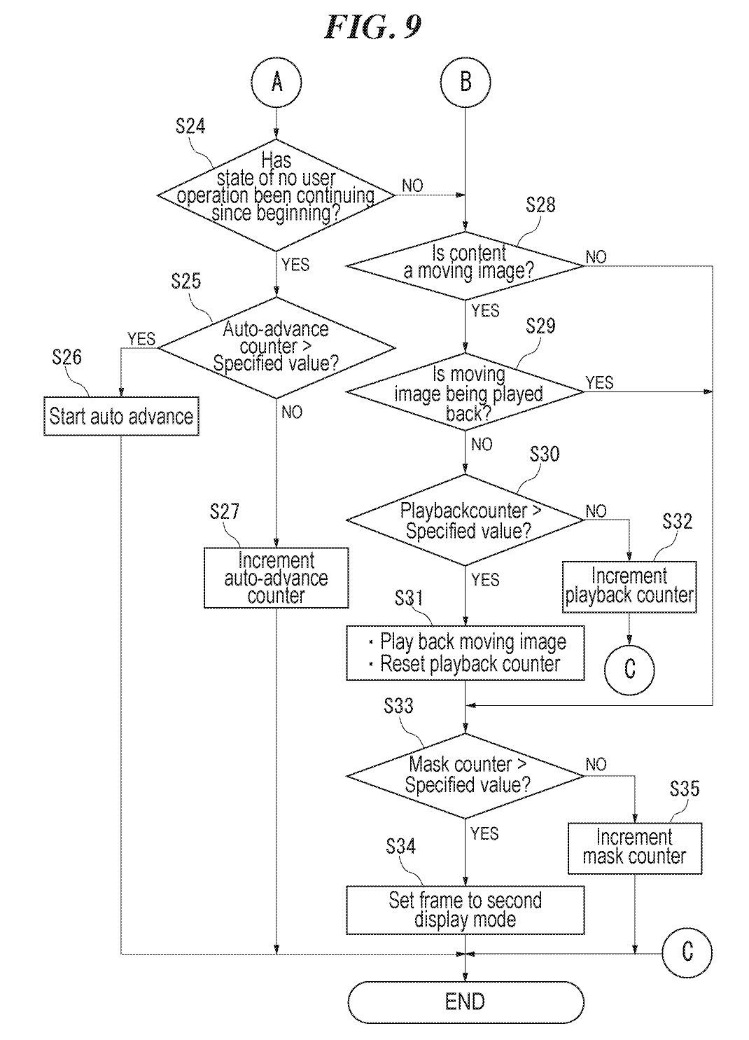

FIGS. 8 and 9 show control of the game apparatus 10 realized by executing the UI control program. Circled A, B, and C located downstream in the flowchart in FIG. 8 continue to the positions of the corresponding symbols in FIG. 9. The process shown in FIGS. 8 and 9 is performed in a state where the game detail screen shown in FIG. 7 is displayed. The process shown in FIGS. 8 and 9 is performed, for example, every frame. Available operations on the game detail screen shown in FIG. 7 are selecting an image S to change the content item displayed in the preview area PV, moving the frame to the purchase button, and confirming the purchase button. The confirmation of the purchase button is omitted in FIG. 8.

When acquiring operation information from the input unit (S20), the game apparatus 10 determines whether the frame indicates the preview area PV or not (S21). If the frame indicates the preview area PV (YES at S21), the game apparatus 10 determines whether the content item is switched or not (S22). If it is determined that the content item is not switched (NO at S22), the game apparatus 10 determines whether the content item in the preview area PV is being auto-advanced or not (S23).

If this determination indicates that the content item is not being auto-advanced (NO at S23), the game apparatus 10 determines whether a state of no user operation has been continuing since the screen transitioned to the game detail screen or not (S24 in FIG. 9). If it is determined at the step S23 that the content item is being auto-advanced (YES at S23), the game apparatus 10 moves to a step of determining whether the content item is a moving image or not (S28 in FIG. 9), which will be described later.

If it is determined at the step S24 that a state of no user operation has been continuing (YES at S24), the game apparatus 10 determines whether an auto-advance counter exceeds a specified value or not (S25). The auto-advance counter is for measuring the time until the auto advance is started. For example, the time until the auto advance starts is five seconds.

If the auto-advance counter does not exceed the specified value (NO at S25), the game apparatus 10 increments the auto-advance counter (S27). If the auto-advance counter exceeds the specified value (YES at S25), the game apparatus 10 starts the auto advance (S26).

If the determination of whether a state of no user operation has been continuing since the beginning or not at the step S24 indicates that a user operation is performed (NO at S24), the game apparatus 10 determines whether the content item displayed in the preview area PV is a moving image or not (S28). The step described above is also a step following the determination at the step S23 that the content item is being auto-advanced (YES at S23). If the determination at the step S28 indicates that the content item is not a moving image (NO at S28), the process moves to a step of determination of a mask counter (S33).

If the content item in the preview area PV is a moving image (YES at S28), the game apparatus 10 determines whether the moving image is being played back or not (S29). In the embodiment, the content item in the preview area PV being a moving image is not played back immediately after the switch of content, but the playback of the moving image is started after a specified time has elapsed since the switch of content. The specified time until the start of playback of the moving image is measured by a playback counter described below. Although the embodiment describes the example in which the game apparatus 10 waits for the specified time after the switch of content before playback of the moving image, the playback of the moving image may be started immediately after the switch of content.

If the determination of whether the moving image is being played back or not indicates that the moving image is not being played back (NO at S29), the game apparatus 10 determines whether the playback counter exceeds a specified value or not (S30). If the playback counter does not exceed the specified value (NO at S30), the game apparatus 10 increments the playback counter (S32). If the playback counter exceeds the specified value (YES at S30), the game apparatus 10 plays back the moving image, and resets the playback counter (S31).

Next, the mask counter for measuring the time until the display mode of the frame is changed will be described. The game apparatus 10 determines whether the mask counter exceeds a specified value or not (S33) if the content item is not a moving image (NO at S28) or if the moving image is being played back (YES at S29, or S31). One example of the specified value is 1.2 seconds. If the mask counter does not exceed the specified value (NO at S33), the game apparatus 10 increments the mask counter (S35). If the mask counter exceeds the specified value (YES at S33), the game apparatus 10 sets the frame surrounding the preview area PV to the second display mode (S34). This process switches the frame to the second display mode, for example, after a specified time has elapsed since the playback of the moving image started.

Next, a case where the frame does not indicate the preview area PV (NO at S21) will be described. This case is, for example, when the frame moves to the purchase button in accordance with a user operation. In this case, the game apparatus 10 sets the frame to the first display mode, and resets the mask counter (S36). In other words, when the frame moves to the purchase button, the frame is returned to the first display mode if the frame has been displayed in the second display mode until then. The game apparatus 10 also stops the auto advance in the preview area PV (S36).

Next, a step for a case where the determination of whether the content item is switched or not (S22) indicates that the content item is switched will be described. This is when the user switches the content item to be displayed on the preview screen. In this case, the game apparatus 10 stops the auto advance, and resets the mask counter (S37). If the frame is in the first display mode at the time of the switch of content, the mask counter is restarted and therefore frequent switching of the display mode can be suppressed. It should be noted that if the frame is already in the second display mode at the time of the switch of content, the second display mode is maintained.

Since the game apparatus 10 of the embodiment displays the frame F of the preview area PV for game image content with an animation effect, it is easy to perceive that the preview area PV is indicated. On the other hand, since the frame F is changed to the less noticeable second display mode when an image in the preview area PV changes, it is easy to pay attention to a change in a game image in the preview area PV without being distracted by the frame F.

While an information processing system of the disclosure has been described in detail above with embodiments, the information processing system of the disclosure is not limited to the above-described embodiments.

Although the above embodiment provides the example of the frame with a blank area in the center, the form of the frame is not limited to this. For example, a rectangular background image superimposed with a slightly smaller game image appears like a frame surrounding the game image. Such a rectangular background image can also be considered a frame. In this case, the display mode of the rectangular background image may be switched from the first display mode to the less noticeable second display mode. In addition, the frame does not need to entirely surround the display area, and the display area may be surrounded by separate components, for example, indicating its four corners.

The disclosure can also be applied to a component other than the frame as long as it indicates the display area. For example, a case may exist where an arrow component or the like indicates a selected display area and the display mode of the arrow component is switched from the first display mode to the less noticeable second display mode.

The control of display mode of the frame described above may be used in other situations. For example, it may be used for a selection screen for a game application to be performed, a menu screen for system settings, or a selection screen for a captured image.

The above embodiment has been described with a moving image, switching still images, and a still image as examples of game images to be displayed. Game images to be displayed may be limited to only two of these types, or may include images displayed as a type other than these types.

Although the control of the display mode of the frame has been described with the example presented in the first embodiment and the example presented in the second embodiment, only one or both of these examples may be applied to the information processing system.

In the example presented in the first embodiment, the frame may be set to the second display mode, for example, after a specified time has elapsed since a moving image was played back. In the example presented in the second embodiment, the frame may be set to the second display mode, for example, at the same time as a moving image is played back.

The step examples shown in FIGS. 6, 8 and 9 are just examples, and the steps may include another step, or may exclude part of the steps. The order of the steps is just an example and, for example, steps may be executed at the same time or in reverse order. Although the steps are described separately for convenience sake, steps may be combined.

A program causing a computer to execute a process may be a single program or a program group comprising a plurality of programs. "A program" does not necessarily mean one program, and may include a program group. A program does not have to be entirely stored in one apparatus. "A program" may mean, for example, the collective of programs stored in the respective apparatuses included in an information processing system.

1. One or more non-transitory computer-readable storage media having stored therein instructions that, when executed, cause one or more processors to perform operations comprising:
displaying an animated frame that surrounds a display area where a content image is displayed; and
switching a display mode of the frame from a first display mode to a second display mode that stands out less than the first display mode in a case where the display area indicated by the frame is an area where the content image displayed in the area changes.

2. The one or more non-transitory computer-readable storage media according to claim 1, wherein the switching of the display mode of the frame comprises switching the display mode of the frame to the second display mode at the same time as the content image displayed in the display area surrounded by the frame changes.

3. The one or more non-transitory computer-readable storage media according to claim 1, wherein the switching of the display mode of the frame comprises switching the display mode of the frame to the second display mode after a specified time has elapsed since the content image displayed in the display area surrounded by the frame changed.

4. The one or more non-transitory computer-readable storage media according to claim 1, the operations further comprising:
changing the content image displayed in the display area surrounded by the frame in accordance with a user operation.

5. The one or more non-transitory computer-readable storage media according to claim 1, wherein the switching of the display mode of the frame comprises:
switching the display mode of the frame to the second display mode after a specified time has elapsed since the content image changed in a case where the content image displayed in the display area surrounded by the frame is a content image that can be changed in accordance with a user operation; and
switching the display mode of the frame to the second display mode at the same time as the content image changes in a case where the content image displayed in the display area surrounded by the frame is a content image that cannot be changed in accordance with a user operation.

6. The one or more non-transitory computer-readable storage media according to claim 4, the operations further comprising:
when the display mode of the frame is the second display mode, maintaining the second display mode regardless of whether the content image displayed in the display area is changed in accordance with a user operation or not.

7. The one or more non-transitory computer-readable storage media according to claim 1, wherein the switching of the display mode of the frame comprises:
switching the display mode of the frame to the second display mode after a specified time has elapsed since the content image displayed in the display area surrounded by the frame changed; and
when the content image displayed in the display area is changed in accordance with a user operation before the specified time has elapsed, switching the display mode of the frame to the second display mode after the specified time has elapsed since the change.

8. The one or more non-transitory computer-readable storage media according to claim 7, the operations further comprising:
when the display mode of the frame is the second display mode, maintaining the second display mode regardless of whether the content image displayed in the display area is changed in accordance with a user operation or not.

9. The one or more non-transitory computer-readable storage media according to claim 1, wherein transparency of the frame in the second display mode is higher than in the first display mode.

10. The one or more non-transitory computer-readable storage media according to claim 9, wherein the transparency of the frame is higher in a dark mode than in a light mode.

11. The one or more non-transitory computer-readable storage media according to claim 1, wherein an animation speed of the frame in the second display mode is lower than in the first display mode.

12. The one or more non-transitory computer-readable storage media according to claim 1, wherein the change of the content image is playback of a moving image.

13. The one or more non-transitory computer-readable storage media according to claim 1, wherein the change of the content image is switching from a still image to another still image.

14. The one or more non-transitory computer-readable storage media according to claim 1, wherein the content image is an image of a game.

15. An information processing system comprising one or more processors and one or more non-transitory computer-readable storage media having stored therein instructions that, when executed, cause the one or more processors to perform operations comprising:
displaying an animated frame that surrounds a display area where a content image is displayed; and
switching a display mode of the frame from a first display mode to a second display mode that stands out less than the first display mode in a case where the display area indicated by the frame is an area whose content image changes.

16. The information processing system according to claim 15, wherein the switching of the display mode of the frame comprises switching the display mode of the frame to the second display mode at the same time as the content image displayed in the display area surrounded by the frame changes.

17. The information processing system according to claim 15, wherein the switching of the display mode of the frame comprises:
switching the display mode of the frame to the second display mode after a specified time has elapsed since the content image displayed in the display area surrounded by the frame changed; and
when the content image displayed in the display area is changed in accordance with a user operation before the specified time has elapsed, switching the display mode of the frame to the second display mode after the specified time has elapsed since the change.

18. A computer-implemented method comprising:
displaying an animated frame that surrounds a display area where a content image is displayed; and
switching a display mode of the frame from a first display mode to a second display mode that stands out less than the first display mode in a case where the display area indicated by the frame is an area whose content image changes.

19. The computer-implemented method according to claim 18, wherein the switching of the display mode of the frame comprises switching the display mode of the frame to the second display mode at the same time as the content image displayed in the display area surrounded by the frame changes.

20. The computer-implemented method according to claim 18, wherein the switching of the display mode of the frame comprises:
switching the display mode of the frame to the second display mode after a specified time has elapsed since the content image displayed in the display area surrounded by the frame changed; and
when the content image displayed in the display area is changed in accordance with a user operation before the specified time has elapsed, switching the display mode of the frame to the second display mode after the specified time has elapsed since the change.
